(19) United States
(12) Patent Application Publication
(10) Pub. No.: US 2026/0235551 A1
(43) Pub. Date: Aug. 13, 2026

(54) AXIAL ELECTRODE CELL SENSING AND SORTING

(71) Applicant: Hewlett-Packard Development Company, L.P., Spring, TX (US)

(72) Inventors: Alexander Govyadinov, Corvallis, OR (US); Viktor Shkolnikov, Palo Alto, CA (US); Christopher Hans Bakker, Corvallis, OR (US)

(73) Assignee: Hewlett-Packard Development Company, L.P., Spring, TX (US)

(21) Appl. No.: 19/474,800

(22) PCT Filed: Apr. 21, 2023
(86) PCT No.: PCT/US2023/019377

§ 371 Date: Oct. 13, 2025

(51) Int. Cl. G01N 27/447

(52) U.S. Cl. CPC G01N 27/44791; G01N 27/4473

(57) ABSTRACT

A microfluidic system includes a cell sensor for high throughput, label-free cell isolation via a parallel electrode impedance sensing structure. A microfluidic device may include a channel fed by a cell-containing reservoir, and an ejection nozzle. The channel is flanked on two sides by electrodes. Electrodes are parallel to the channel axis. Positive and negative electrodes may be on one side of the channel and a ground electrode on the opposite side a differential sensing arrangement. A potential may be applied to the electrodes and the resulting current sensed, such as a difference current between the two electrodes. The sensor may detect presence of a cell based on peak-to-peak signal structure. The dispense head may move relative to a multiwell plate such that a new well is exposed under the nozzle. The cell may move via evaporation driven flow to the nozzle orifice, ready to be ejected.

### BACKGROUND

Microfluidic devices may include a channel through which a fluid containing biological cells can flow. But detecting, selecting, and directing cells, especially on a single-cell basis, is challenging due to cell size and the potential of cells to clump together. To generate a pure cell line, or biologics from a single cell line, for example, a user needs to have high confidence that the cell line was derived from a single cell and had desired properties.

### BRIEF DESCRIPTION OF THE DRAWINGS

FIG. 1 depicts a digital step flow through a microfluidic channel according to various potential embodiments.

FIG. 2 depicts an example differential sensing electrode arrangement, and an example impedance difference versus cell position graph, according to various potential embodiments.

FIG. 3 depicts an example numerical simulation of cells in a differential axial sensor according to various potential embodiments.

FIG. 4 depicts an example differential axial sensor variation, with electrodes inside sensor channel, according to various potential embodiments.

FIG. 5 depicts an example numerical simulation of a cell in a differential axial sensor according to various potential embodiments.

FIG. 6 depicts an example signal simulation with two cells in the sensing region according to various potential embodiments.

FIG. 7 depicts an example stepping impedance measurement according to various potential embodiments.

FIG. 8 depicts an example a simulation illustrating effects of electrode size and gap according to various potential embodiments.

FIG. 9 depicts an example series of differential pairs according to various potential embodiments.

FIG. 10 depicts an example simulation of multiple electrode sequence according to various potential embodiments.

FIG. 11 depicts an example dual drop weight design for precision digital cell positioning according to various potential embodiments.

FIG. 12 depicts an example precision digital cell cytometry and cell positioning according to various potential embodiments.

FIG. 13 depicts an example precision digital cell cytometry and cell positioning with alternative cell ejection according to various potential embodiments.

FIG. 14 depicts an example wide sensing chamber with sensor array according to various potential embodiments.

FIG. 15 depicts an example wide sensing chamber with sensor array without negative bias according to various potential embodiments.

FIG. 16 depicts an example electrode lattice according to various potential embodiments.

FIG. 17 depicts an example of multiple channels that are parallel according to various potential embodiments.

FIG. 18 depicts an example of multiple channels in parallel with multiplexed sensors according to various potential embodiments.

FIG. 19 depicts an example system integration according to various potential embodiments.

FIG. 20 depicts an example implementation circuitry according to various potential embodiments.

FIG. 21 depicts example implementations with single pairs of electrodes according to various potential embodiments.

FIG. 22 depicts an example implementation with a wider channel according to various potential embodiments.

FIG. 23 depicts an example method that may comprise determining signal structures as cells travel through a microfluidic channel, and using signal structures to detect a cell according to various potential embodiments.

FIG. 24 depicts an example method of detecting a cell traveling through a microfluidic channel of a microfluidic device according to various potential embodiments.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, may be arranged, substituted, combined, and designed in a wide variety of different configurations, all of which are explicitly contemplated and make part of this disclosure.

Various implementations of the disclosed approach enable higher throughput isolation and sorting of cells (and/or related particles, such as cell clumps and/or debris). Cell isolation may be achieved via a sensor with a parallel electrode impedance sensing structure. Various example systems and devices may comprise, or in some examples may consist of, a microfluidic channel fed by a cell-containing reservoir, with an ejection nozzle, and flanked on two sides by electrodes. The electrodes are parallel to the channel axis, such that a cell traveling in the channel encounters more than one electrode simultaneously (as opposed to a parallel structure in which the cell would encounter one electrode at a time).

In example devices in which electrodes are positioned axially relative to the cell's travel, the cell encounters two electrodes simultaneously. This produces a longer impedance signal, as the length of the signal is proportional to the cell size, rather than the gap between the electrodes. This increases the amount of information that can be obtained from the cell, and lends to designs in which larger cells, cell clumps, and debris are less likely to clog the system. Example microfluidic devices may be part of, or incorporated in, a microfluidic system with additional components, as further discussed below and represented in the figures.

In example implementations, a set of three electrodes may be used: a positive electrode and a negative electrode on one side of the channel, and a ground electrode on an opposing side of the channel. Such an arrangement may be referred to herein as a “differential sensing arrangement.” In example implementations, a potential may be applied to the electrodes and the resulting current sensed. For such a differential sensing arrangement, a difference current may be sensed between the two electrodes (e.g., via a differential amplifier).

In operation, example implementations include a sensor that detects presence of a cell by recognizing the specific peak-to-peak signal structure (further discussed below), which can be based on numerical modeling, at which point the firing of an ejection resistor may stop. The dispense head can then be moved relative to a multiwell plate such that a new well is exposed under the ejection nozzle. In example implementations, the cell may move via evaporation driven flow (e.g., evaporation occurring at the nozzle) to the nozzle orifice, and there wait to be ejected into the well.

Example implementations of the disclosed approach provide more effective automated sorting of cells based on examination of the cells' multiple electrical properties, and singulating them into individual wells for further propagation or analysis. Pure cell lines (e.g., those derived from a single cell with well-defined properties) may be necessary for both high fidelity production of biologics, as well as for understanding fundamental mechanisms of cellular function. To generate such pure cell lines, or to generate biologics from a single cell line, a user benefits from higher confidence (1) that the cell line was derived from a single cell (monoclonality), and (2) that the cell had the desired properties. The second criterion can reduce the number of cells that need to be cultured (e.g., cells with undesirable properties can be eliminated), and reduces the amount of quality control needed for the cultured cells. Advantageously, in example implementations, such sorting and singulation can be label free, so that labeling agents (e.g., antibodies) and/or other fluorescent species do not interfere with cell signaling and cellular function or analysis.

Example implementations of this device may be integrated into a system with a cell sensing device, a multiwell stage with a well plate, and control electronics. The control electronics may transduce the signal from the electrodes, analyze the signal waveform, and make a decision on whether the object passing the electrodes is, for example, a clump or a cell, and the location of the cell relative to the electrodes. The control electronics may then move the stage such that a well of a multiwell plate aligns below the dispenser, and request the firing system to fire a set number of pulses to eject the cell based on the distance between the electrodes and the ejection nozzle.

With respect to operation of example implementations, when the sensor detects presence of the cell via recognizing the specific peak-to-peak signal structure, the firing of the ejection resistor stops. The dispense head moves relative to a multiwell plate such that a new well is exposed under the nozzle. The cell may move via evaporation driven flow (evaporation occurring at the nozzle) to the nozzle orifice, and there wait, ready to be ejected. During this time, the sensor is kept turned on in example implementations, so that it can detect an event where another cell enters behind the first cell. If this happens, the first cell is ejected, then based on the signal, the number of firing events to the second cell is calculated. The stage is moved to the next well. The second cell is moved toward the ejection nozzle, using this number of firing events, and then ejected into the well prepared for it.

In example systems in which electrodes are positioned axially relative to the cell's travel, the cell encounters two electrodes. This produces a longer impedance signal, as the length of the signal is proportional to the cell size, rather than the gap between the electrodes. This increases the amount of information that can be obtained from the cell, and lends to designs where larger cells, cell clumps, and debris are less likely to clog the system.

Advantageously, the disclosed approach can enable label-free cell sorting. The approach can achieve high throughput, with low risk of clogging, allowing for sorting of large numbers of cells. The approach additionally provides the ability to measure different cell properties, including size and stiffness and correlate these measurements to dispensed cells. Further, the disclosed approach achieves low electrical cross-talk and decreased noise level. These and other advantages will be further disclosed below.

In some examples, the disclosure relates to a microfluidic device with a microfluidic channel that is connected to a reservoir, an ejection nozzle, and a sensing region. The sensing region may include a set of electrodes flanking the microfluidic channel on two sides. In some examples, the set of electrodes includes a positive electrode, a negative electrode, and a ground electrode. One or more of electrodes (e.g., the positive electrode and the negative electrode) may be positioned on a first side of the microfluidic channel, and one or more of the electrodes (e.g., the ground electrode) may be positioned on a second side of the microfluidic channel opposing the first side of the microfluidic channel. A plurality of the electrodes (e.g., the positive electrode, the negative electrode, and the ground electrode) may have an electrode axis that is parallel to a channel axis (e.g., an axis corresponding to a path of travel of a fluid or elements thereof moving through the microfluidic channel) of the microfluidic channel. The microfluidic channel and the set of electrodes can be arranged such that a cell traveling through the microfluidic channel encounters at least two electrodes simultaneously.

In some examples, the disclosure relates to a method that comprises detecting a cell traveling through a microfluidic channel of a microfluidic device. The microfluidic device may include a sensing region that includes a set of electrodes flanking the microfluidic channel on opposing sides. The electrodes may include an electrode axis (e.g., along a length of the electrodes) that is parallel to a channel axis of the microfluidic channel such that the cell encounters at least two electrodes simultaneously. Detecting the cell may comprise detecting an electrical signal at the set of electrodes, and determining that the cell is present at the sensing region based on the electrical signal (e.g., based on a structure or waveform of the electrical signal as the signal is changes as a result of the presence, movement, size, and/or other characteristics of the cell in the microfluidic channel).

In some examples, the disclosure relates to a microfluidic system that includes a microfluidic device with a microfluidic channel fed by a reservoir. The microfluidic channel may comprise a sensing region with a set of electrodes, such as one or more positive electrodes, one or more negative electrodes, and one or more ground electrodes. A plurality (or all) of the electrodes in the set of electrodes may have an electrode axis that is parallel to a channel axis of the microfluidic channel. At least one of the electrodes (e.g., the positive electrode and the negative electrode) may be positioned on a first side of the microfluidic channel, and at least one of the remaining electrodes (e.g., the ground electrode) may be positioned on a second side of the microfluidic channel opposing the first side of the microfluidic channel. The microfluidic channel and the set of electrodes may be arranged such that a cell traveling through the microfluidic channel encounters at least two electrodes simultaneously (e.g., in “parallel” or otherwise at substantially the same time) as opposed to sequentially (e.g., in “series” or otherwise one after another).

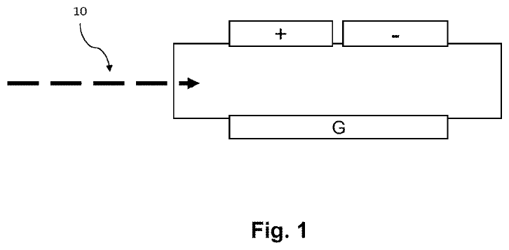

Referring to the example implementation depicted in FIG. 1, the region bracketed by electrodes may be referred to herein as the sensing region. In example implementations, the volume of the sensing region is at least as large as the drop volume produced by the ejection resistor. In some implementations, the sensor volume is an integer multiple of the drop volume, so that the cell can be moved a predefined length in the sensing region in a “digital” manner, as depicted by the broken line 10 at the top of FIG. 1. Example implementations of the disclosed approach substitute analogue flow with pseudo-digital step-flow using droplet ejection or pumping. The sensing region volume/length ratio is larger than displacement volume/step ratio. As an additional advantage, such an approach allows for use of “slower” (and potentially more economical) electronics to interrogate the cell's impedance, as the cell can be stopped in the sensing region between electrodes.

Example implementations moreover allow for interrogating the cell with several different frequencies and obtaining an impedance spectra of the cell, as to better determine the cell identity.

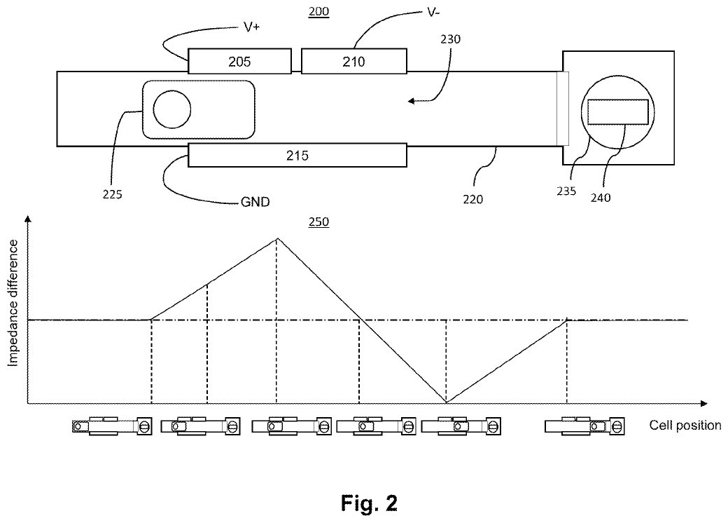

FIG. 2 illustrates a differential sensing arrangement according to potential implementations. An example microfluidic device 200 comprises a channel 220 with electrodes 205 (shown as a positive electrode V+), 210 (shown as a negative electrode V−), and 215 (shown as a ground electrode GND). A cell 225 is moving through the microfluidic channel 220. As shown in FIG. 2, cell 225 is entering sensing region 230 (used interchangeably with “detection region”) between bracketed by the electrodes 205, 210, and 215. The microfluidic channel 220 terminates in an ejection nozzle 235 with an ejection resistor 240. A difference between the impedance of V+ to GND and V− to GND is measured, with the resulting theoretical plot of impedance difference versus cell position (as the cell moves from left to right) in the detection region shown at 250 at the bottom of FIG. 2.

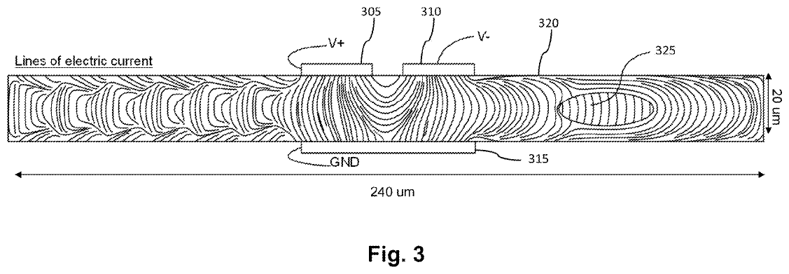

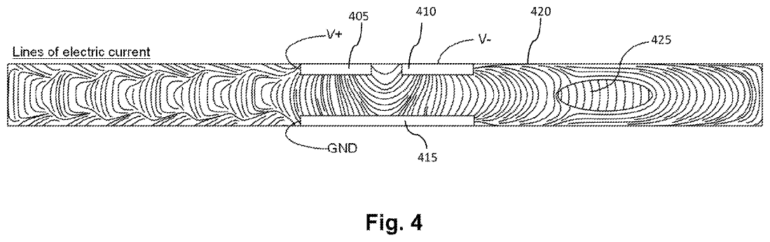

FIG. 3 provides a numerical simulation of the cell in a differential axial sensor like the one depicted in FIG. 2. The simulation illustrated in FIG. 3 was generated using the COMSOL Multiphysics software. FIG. 3 depicts electrodes 305, 310, and 315 with a cell 325 moving through microfluidics channel 320. The lines in the microfluidic channel 320 are lines of electric current through the channel, which is affected by the presence of cell 325. FIG. 4 depicts an alternative differential axial sensor variation in which electrodes (405, 410, and 415) are positioned inside the microfluidic channel 420. Lines of electric current, which are affected by presence of the cell, are also shown. Changes in electric profile affect detectable signal structures, which can be indicative of the presence of a cell, and/or indicative of one or more characteristics of the cell (e.g., cell size and/or cell type). The example arrangement of FIG. 4 may increase signal strength and decrease signal variation due to the relative position of the cell in the channel cross section. In example implementations, the sensor channel cross-section is comparable with the cell dimensions. Typical cell diameters depend on cell types, ranging from about 0.1 μm (micron) to 100 μm, with typical cell sizes ranging from 10 to 15 μm. The sensor channel cross-section could, in various implementations, range from, for example, 2 μm to 100 μm, or 10 to 20 μm. To further increase the sensor volume, a sensor array can be implemented (example array arrangements are further discussed below).

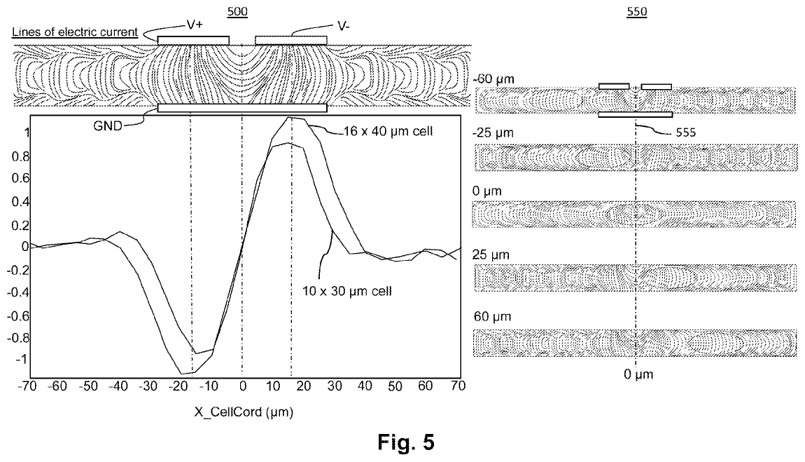

FIG. 5 provides a numerical (COMSOL) simulation of a cell in a differential axial sensor such as the ones depicted in FIGS. 2, 3, and 4. At 500, a plot of current versus position in a microchannel (relative to centroid 555, with upstream positions depicted by the negative values, and downstream positions depicted as positive values) for two different cells (one that is 16 μm by 40 μm, and another that is 10 μm by 30 μm) are shown. At 550, the cell is shown at 5 positions relative to the center line 555: −60 μm, −25 μm, 0 μm, 25 um, and 60 μm. Cells can be distinguished based on observations of signal structure.

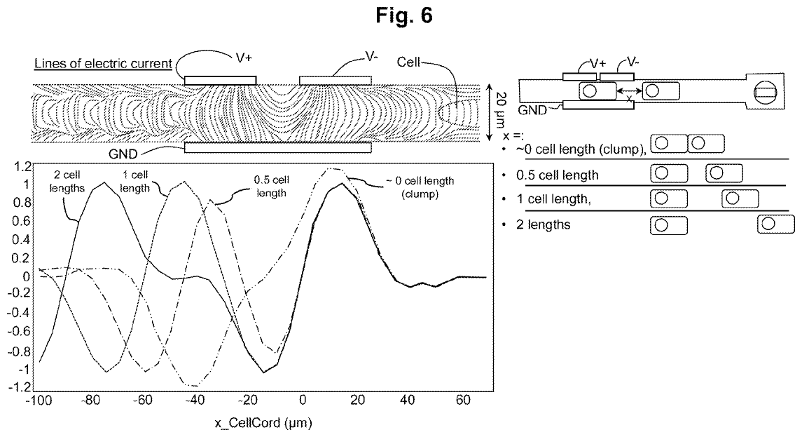

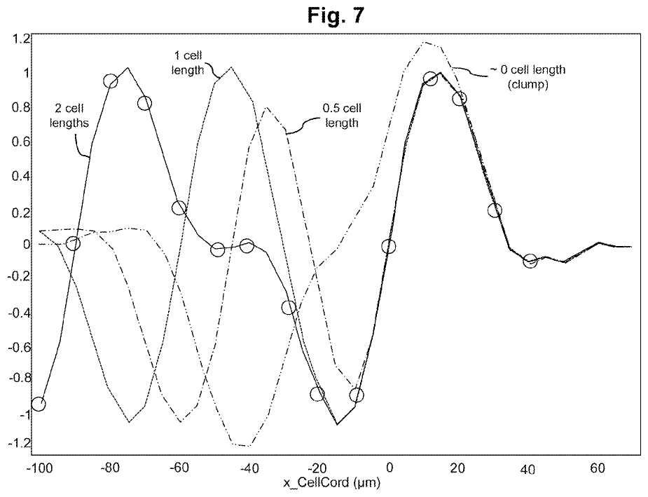

FIG. 6 provides a simulation signal with two cells in the sensing region according to potential implementations. A cell clump versus a single cell versus two cells next to each other can be differentiated based on signal structure. One cell can be moved after another by noting the distance between the cells. Consider, for a 20 μm×20 μm cross-section, to move 1 μm, is a volume of 0.4 picoliters (pL), to move 10 μm, a 4 pL volume. 10 μm is about 1 cell length. By ejecting 4 pL drops, one cell length can be moved, so two cells separated by 1 cell diameter can be dispensed separately. FIG. 7 illustrates that a cell can be moved by 4 pL, which for a 20 μm×20 μm cross section is 10 μm. After each firing, impedance can be recorded as shown by the circles in the plot of FIG. 7. During each measurement, measurements at different frequencies can be taken and an impedance spectra obtained at each point.

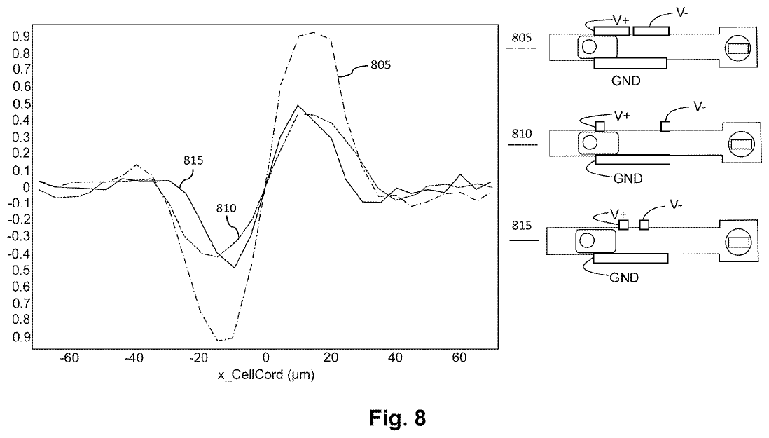

FIG. 8 depicts a simulation illustrating effects of electrode size and gap size according to various potential implementations. At 805, an electrode arrangement with a gap of 10 μm and electrode length of 20 μm is depicted, at 810 a gap of 30 μm and electrode length of 5 μm is depicted, and at 815 a gap of 10 μm and electrode length of 5 μm is depicted. The corresponding waveforms are shown in the plot.

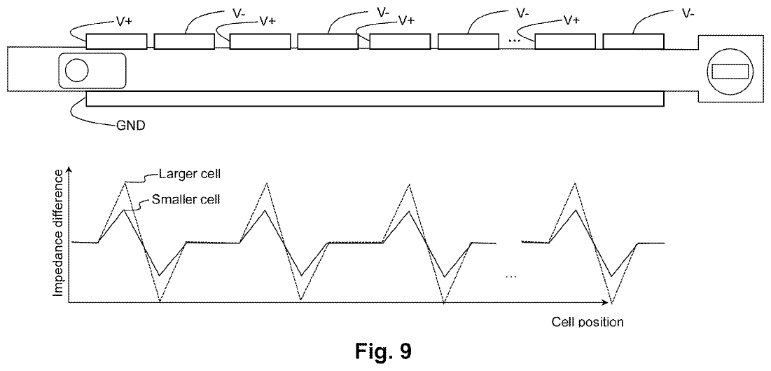

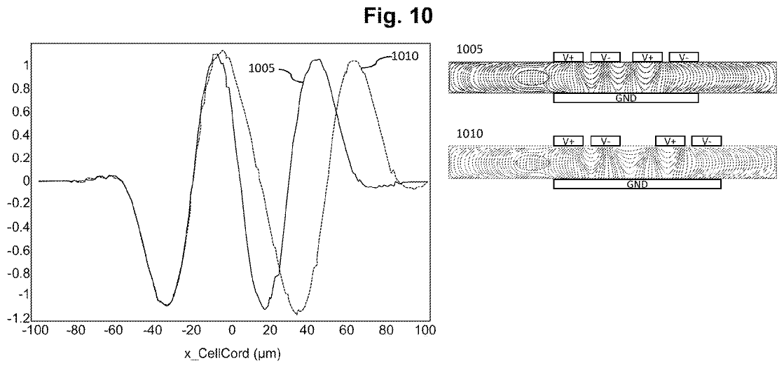

FIG. 9 depicts differential sensing with a series of differential pairs according to potential implementations. A difference between the impedance of V+ to GND is measured, and a difference between the impedance of V− to GND is measured. As cells moves from the differential pairs, more data is obtained on the cell's ability to block the channel, via changes in impedance, as depicted in the plot. This allows for more certainty in measuring the cells size and therefore sorting of the cell. FIG. 10 depicts a simulation of multiple electrode sequences, and more specifically, two pairs, according to potential embodiments. At 1005, an arrangement with 10 μm between electrode pairs and an electrode length of 20 μm is depicted, and at 1010, an arrangement with 30 μm between electrode pairs and an electrode length of 20 μm is depicted, with corresponding plots.

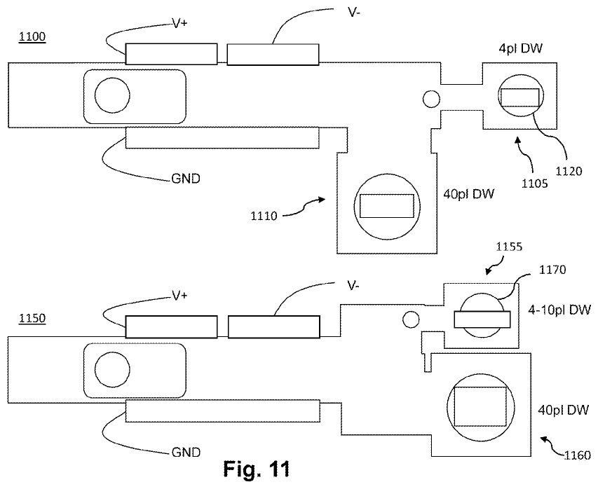

FIG. 11 depicts a dual drop weight design for precision digital cell positioning according to potential implementations. Example implementation 1100 is depicted at the top of FIG. 11, and example implementation 1150 is depicted at the bottom of FIG. 11. A smaller drop weight (DW) nozzle 1105 (e.g., 4 pL) in 1100 or 1155 (e.g., 4-10 pL) in 1150 is used to move the cell with high precision through the sensing region. A larger DW nozzle 1110 (e.g., 40 pL) in 1100 or 1160 (e.g., 40 pL) in 1150 is used to eject the cell into the well plate. Small drop weight enables shrinking the detection volume and thus the area used to detect cells on a microfluidic chip. A smaller detection region has a smaller length, and thus has a smaller fluidic resistance. This in turn allows for faster refill rates and therefore faster firing rates, and potentially higher throughput. The low drop weight nozzle 1105 and 1155 has particle blocking structures (e.g., pillars) 1120 and 1170, respectively, to prevent the cell from entering that nozzle, and clogging the nozzle.

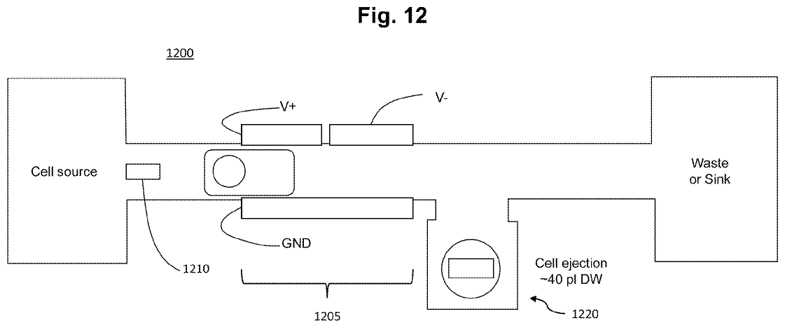

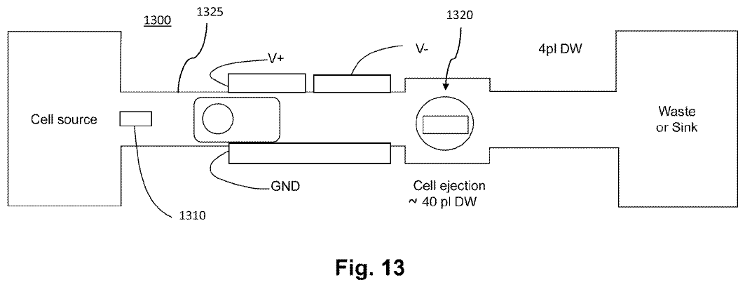

FIG. 12 depicts precision digital cell cytometry and cell positioning according to potential implementations. FIG. 12 depicts example implementation 1200. A small-stepper upstream pump 1210 can be used to move the cell with high precision steps (1-20 μm each step) through the sensing region 1205. An approximately 20 pL to 80 pL DW nozzle 1220 can be used to eject the cell into the well plate (not shown in FIG. 12). The stepper pump 1210 enables shrinking the detection volume and thus the area detecting on the microfluidic chip. Smaller detection regions have a smaller length, and therefore have a smaller fluidic resistance. This in turn allows for faster refill rates and therefore faster firing rates, and potentially higher throughput. The upstream pump 1210 could be any stepper-like pulsating pump, such as peristaltic, syringe, thermal inkjet (TIJ)-based inertial pump, piezo, and/or any other type of pump enabling small volume displacement per step. This arrangement additionally enables separation of clumped cells from a single cell stream. FIG. 13 depicts precision digital cell cytometry and cell positioning according to other potential implementations. In FIG. 13, the ejection nozzle 1320 of device 1300 is aligned with the microfluidic channel 1325.

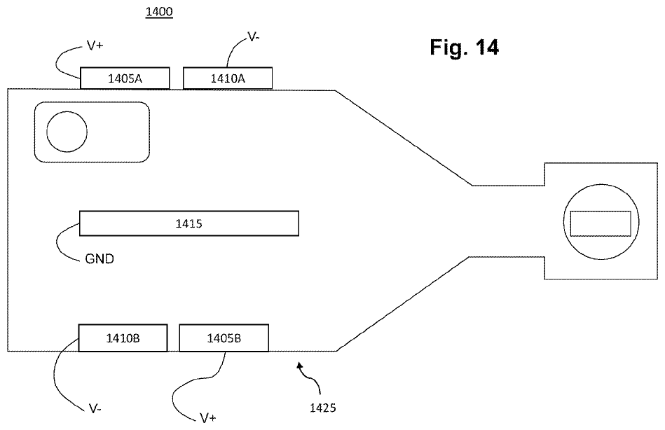

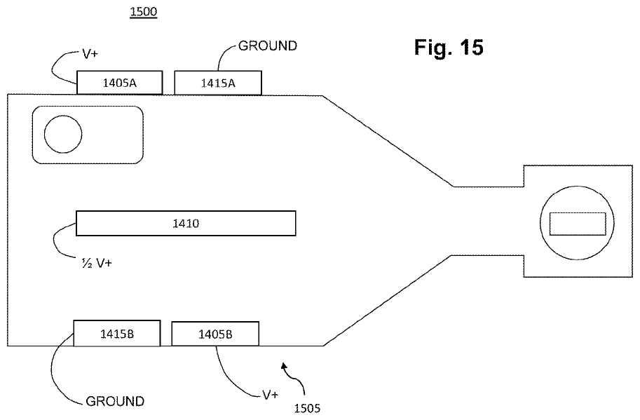

FIG. 14 depicts an example device 1400 with a wide sensing chamber 1425 with a sensor array according to potential implementations. The microfluidic channel of the wide sensing chamber 1425 is significantly wider than cell diameter in a differential sensing arrangement. The arrangement depicted in FIG. 14 reduces shear stresses on cells moving through the channel, and thus reduces probability of clogging. This arrangement is also able to process a larger number of cells. In FIG. 14, device 1400 includes a sensing array with two positive electrodes 1405A, 1405B, two negative electrodes 1410A, 1410B, and one ground electrode 1415. FIG. 15 depicts an example device 1500 with a wide sensing chamber 1505 with a sensor array that does not include a negative bias according to potential implementations. In FIG. 15, device 1500 includes a sensing array with two positive electrodes 1405A, 1405B at voltage V, one positive electrode at voltage 0.5V, and two ground electrodes 1415A, 1415B (with no negative electrode). As in FIG. 14, the channel of chamber 1505 is significantly wider than cell diameter in a differential sensing arrangement. Also as with the arrangement of FIG. 14, the version of FIG. 15 reduces shear stresses on cells moving through the channel, and thus reduces probability of clogging. This arrangement is also able to process a larger number of cells. The configuration depicted in FIG. 15 can be used, for example, in CD40 integrated circuits (ICs) to avoid negative bias of sensing electrodes. The chamber 1505 may have a partition 1410 in the middle to separate it in two passages enabling cell placement in center between electrodes 1405A-1415A and 1410 and 1415B-1405B and 1410 for a better signal-to-noise ratio (SNR).

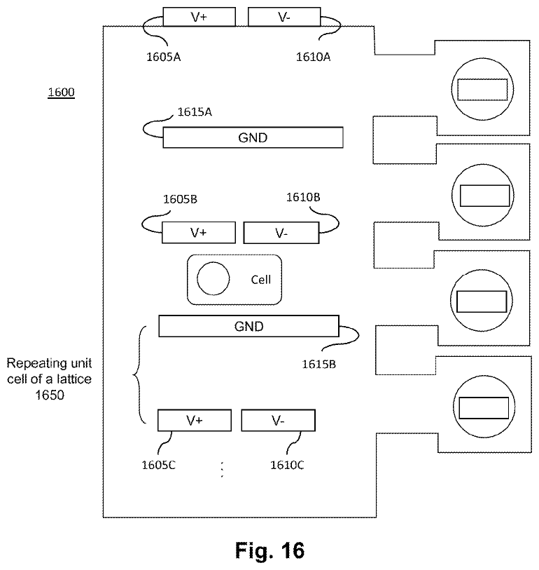

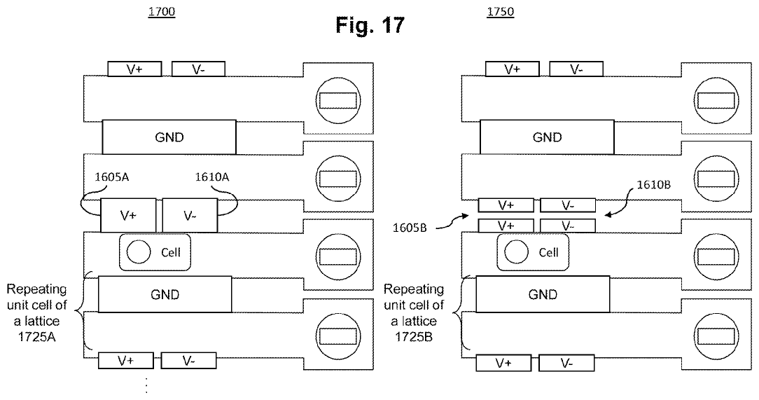

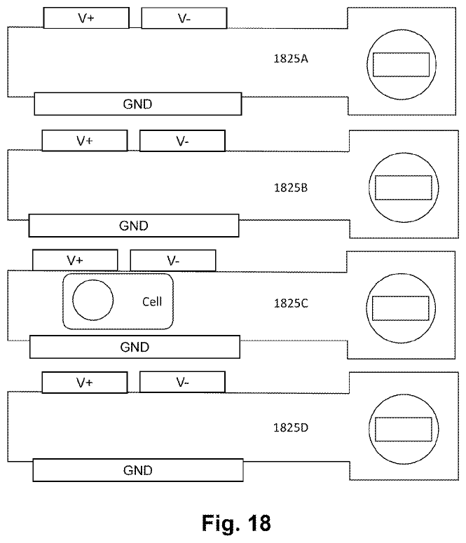

FIG. 16 depicts an example device 1600 with an electrode lattice according to potential implementations. Each repeating unit 1650 of the lattice comprises a ground electrode, a positive electrode, and a negative electrode. In device 1600, adjacent lattice units share a ground electrode. In FIG. 16, a first functional unit (at the top) comprises a positive electrode 1605A, a negative electrode 1610A, and a ground electrode 1615A. A second functional unit (in the middle) comprises a positive electrode 1605B, a negative electrode 1610B, and ground electrode 1615A and/or ground electrode 1615B. And a third functional unit (at the bottom) comprises a positive electrode 1605C, a negative electrode 1610C, and a ground electrode 1615B. The illustrated arrangement of FIG. 16 greatly reduces shear stress by allowing flowing in a die structure on the cell, and reduces probability of clogging. This design is thus able to process a larger number of cells and increase throughput. The repeating unit of the lattice is identified. Similar to chamber 1505 in FIG. 15, the chamber in FIG. 16 can have partitions in the ground electrodes (e.g., 1615A and 1615B) to enable centralized placement of cells between sensing electrodes 1605A-1610A and 1615A and between sensing electrodes 1605B-1610B and 1615B. FIG. 17 illustrates multiple channels in parallel according to potential implementations. The repeating unit 1725A of the lattice of example device 1700 is identified, and is the repeating unit 1725B of the lattice of example device 1750. Device 1700, in one of its lattice units, includes a single large positive electrode 1605A and a single negative electrode 1610A, while device 1750, in one of its lattice units, includes a pair of positive electrodes 1605B and a pair of negative electrodes 1610B. FIG. 18 depicts multiple channels 1825, 1825B, 1825C, 1825D in parallel, with multiplexed sensors.

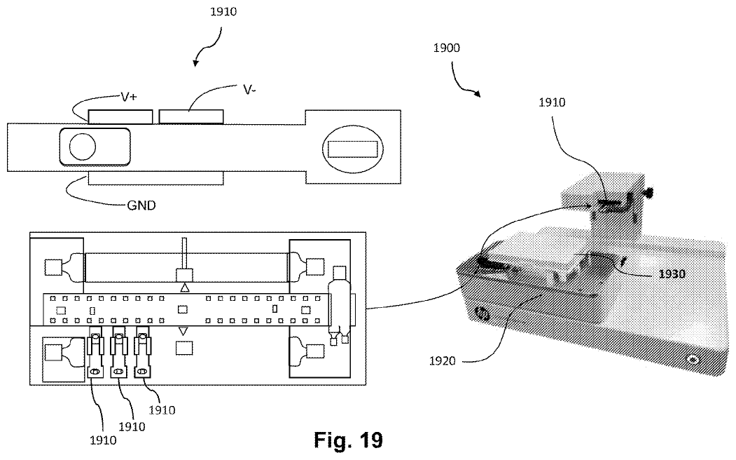

FIG. 19 depicts an example microfluidic device 1910 integrated in a microfluidic system 1900 according to potential embodiments. The system 1900 includes a cartridge 1910, and a stage 1920 with a multiwell plate positioned thereon. The system 1900, for example, may comprise a controller. Various operations as disclosed herein may be performed by a controller of any of the example implementations. The controller may be a feedback controller and may include or be associated with one or more processing units or processors and one or more memories. The processing unit(s) may include a microprocessor, programmable logic controller (PLC) chip, an application specific integrated circuit (ASIC), one or more field programmable gate arrays (FPGAs), a digital signal processor (DSP), a group of processing components, or other suitable electronic processing components. The processing unit(s) of the controller 305 may be configured to execute computer-readable instructions for performing the operations described herein. The processing unit(s) may be implemented in hardware, firmware, software, or any combination thereof. “Executing a computer-readable instruction” means that the processing unit(s) may perform operation(s) called for by that instruction. The processing unit(s) may retrieve the instruction from a memory associated with the controller for execution and copy the instruction in an executable form to a physical memory. In some embodiments, the processing unit(s) may be configured to execute the instruction without first copying the instruction to the physical memory. The instruction may be written using one or more programming languages, scripting languages, assembly languages, etc. Thus, the controller, via its associated processing unit(s), may be configured to execute instructions, algorithms, commands, or programs stored in the memory associated with the controller. In some examples, the controller may be electrically and/or communicably coupled (such that, e.g., control signals may transmitted to systems or devices as commands to perform certain operations, and inputs may be received from the systems or devices), directly or indirectly, to sensors and sensor circuits, electrodes, differential amplifiers, nozzles, readers, stages, etc., and may be configured to provide signals that activate or deactivate systems or devices and functionalities thereof. The controllers may be involved in the numerical modeling used from which signal waveforms (e.g., peak-to-peak structures) are obtained. In various examples, multiple controllers may cooperate to implement the operations discussed herein.

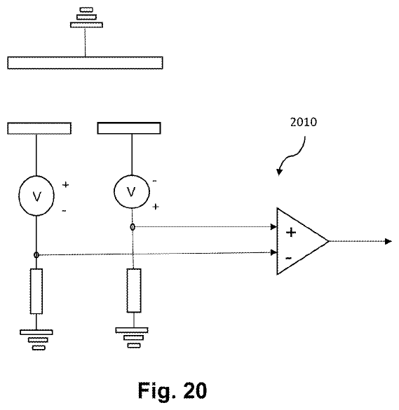

FIG. 20 depicts a circuit for detecting electrical signals indicative of cell presence and different cell properties (e.g., size, stiffness, etc.) according to potential embodiments, with low electrical cross-talk and decreased noise level. The circuit includes a differential amplifier 2010 to produce an output that is proportional to a difference between two input signals (such as V+ and V−). An example device is the Tektronix ADA400A Differential Preamplifier.

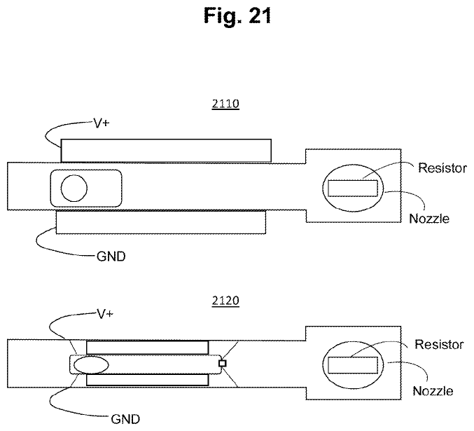

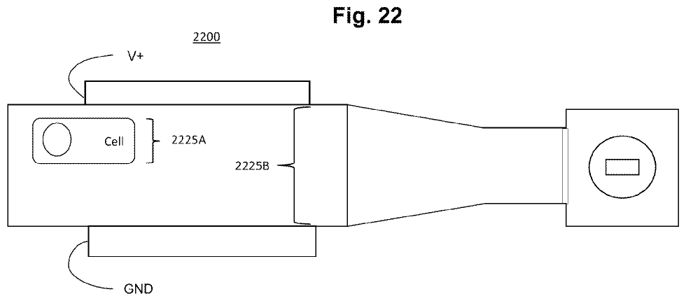

FIG. 21 depicts two alternative arrangements according to potential implementations. At 2110, a single pair of electrodes that are sized similarly to the cell, and at 2120, a single pair of electrodes with a constriction. FIG. 22 depicts a version of an example device 2200 with a channel (with a width 2225B) that is significantly wider than cell diameter (2225A). Typical cell diameters depend on cell types, with certain bacterial cells ranging in diameter from 0.1 μm to 2 μm, certain mammalian cells ranging in diameter from 5 μm to 20 μm, and certain large mammalian cells ranging in diameter from 25 μm to 100 μm, with most typical cell sizes ranging from 10 to 15 μm. The channel diameters could, in various implementations, range from, for example, 2 μm to 100 μm. In some example devices, the linear cross-section of the channel would have a diameter of 10 to 20 μm. This arrangement is less likely to shear cells and the dispensed cells are more likely to have higher viability. The device 2200 is also less prone to clogging. However, as the cell occupies less of the area of the channel, the change in impedance due to the cell blocking the electrode may be less, and thus the sensitivity of the electrodes to cell presence may correspondingly be less, potentially making it more difficult to distinguish cells.

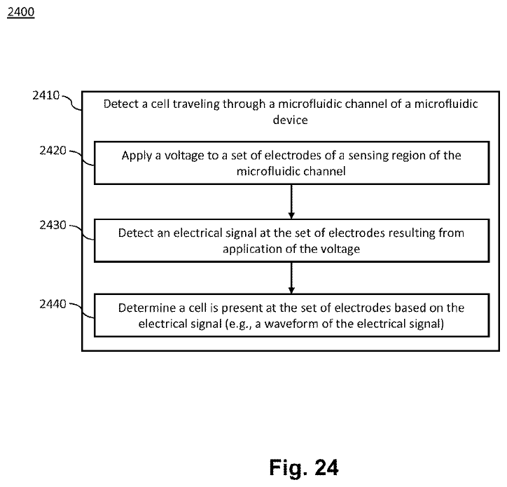

Referring to FIG. 24, in some examples, the disclosure is about a method 2400 comprising detecting a cell traveling through a microfluidic channel of a microfluidic device 2410, wherein detecting the cell comprises: detecting an electrical signal at the set of electrodes 2430; and determining that the cell is present at the sensing region based on the electrical signal 2440. The method can further comprise the application of a voltage to the set of electrodes 2420, wherein the electrical signal results from application of the voltage. A cell can be considered to be present at the sensing region based on a signal waveform of the electrical signal.

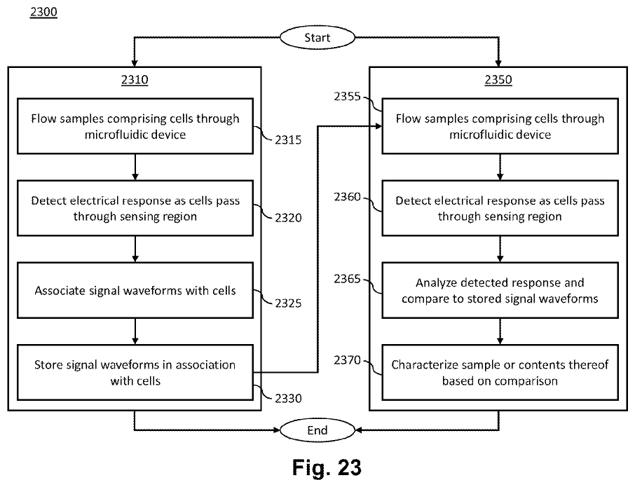

FIG. 23 depicts an example process or method 2300 for generating waveforms and/or detecting cells traveling through using the waveforms according to various potential embodiments. Block 2310, which includes blocks 2315, 2320, 2325, and 2330, corresponds to a first sub-process or sub-method of generation waveforms, and block 2350, which includes blocks 2355, 2360, 2365, and 2370, corresponds to a second sub-process or sub-method of using the generated waveforms to detect, identify, and/or characterize cells. In various implementations, only block 2310 may be performed to generate waveforms, only block 2350 may be performed to use generated waveforms (e.g., if waveforms are already available in a memory or computer storage medium) to detect cells, or both blocks 2310 and 2350 may be performed in succession.

Method 2300 may begin, at block 2315, by flowing a set of samples with known cells through a microfluidic device. At block 2320, a sensor (which may comprise a sensing region that includes sensing electrodes in the differential sensing arrangement disclosed herein) may detect electrical responses and/or changes in electrical signals (see above discussion of lines of electric current with respect to changes in electrical response resulting from the presence and/or characteristics of cells in the sensing region). At block 2325, signal waveforms (e.g., peak-to-peak) may be associated with the presence and/or characteristics of the known cells (further discussed above with respect to, e.g., FIGS. 5 to 10). The waveforms may vary based on the exact configuration of the microfluidic device (e.g., dimensions such as width of channel, distances between electrodes and their particular arrangement, etc.) as well as the characteristics of the cells (e.g., size and/or type of cell and its flow through the channel) and/or of reagents (e.g., viscosity). At 2230, the waveforms may be stored in a database or other computer-readable non-volatile storage medium for subsequent use. Method 2300 may end after block 2330 of sub-process or sub-method 2310, or method 2300 may proceed to block 2350, such as block 2355.

In various implementations, method 2300 may begin at sub-method 2350, or may proceed to sub-method 2350 after sub-method 2310 (or a step thereof). At block 2355, samples may be flowed through a microfluidic device of a microfluidic system. At 2360, electrical responses at a sensing region of the microfluidic device may be detected as the sample (potentially containing a cell) pass through the sensing region. At block 2365, the electrical response detected at block 2360 is analyzed to identify, for example, a signal waveform. The signal waveform can then be compared to known signal waveforms (which may have been obtained through block 2310 and stored, at block 2330, in a database or other computer storage). If there is a match, or a sufficiently-close waveform, then the presence and/or one or more characteristics of a cell can be determined. Method 2300 may then end.

The disclosure has been described above with reference to the various examples. However, it is to be understood that various modifications may be made in form and detail without departing from the scope of the disclosure as defined by the appended claims and their equivalents.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An example storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps.

Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

As utilized herein, the terms “approximately,” “about,” “substantially”, and similar terms are intended to have a broad meaning in harmony with the common and accepted usage by those of ordinary skill in the art to which the subject matter of this disclosure pertains. These terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

It should be noted that the terms “exemplary,” “example,” “potential,” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” “up,” “down”) may merely be used to describe the orientation of various elements as arranged in the Figures. It should be noted that the orientation of various elements may differ according to other potential embodiments, and that such variations are intended to be encompassed by the present disclosure.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It is important to note that the construction and arrangement of the devices, assemblies, and steps as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

Sample implementations are disclosed below, in order to represent illustrative examples, which may be further modified, combined, constrained, etc. according to the entirety of this disclosure.

Example AA: AA microfluidic device comprising: a microfluidic channel connected to a reservoir; an ejection nozzle; and a sensing region comprising a set of electrodes flanking the microfluidic channel on two sides, the set of electrodes comprising a positive electrode, a negative electrode, and a ground electrode, the positive electrode and the negative electrode positioned on a first side of the microfluidic channel, and the ground electrode positioned on a second side of the microfluidic channel opposing the first side of the microfluidic channel, the positive electrode, the negative electrode, and the ground electrode having an electrode axis parallel to a channel axis of the microfluidic channel.

Example AB: The device of Example AA, wherein the microfluidic channel and the set of electrodes are arranged such that a cell traveling through the microfluidic channel encounters at least two electrodes simultaneously.

Example AC: The device of either Example AA or AB, wherein a volume of the sensing region is at least as large as a drop volume produced by the ejection nozzle.

Example AD: The device of Example AC, wherein a volume of the sensing region is an integer multiple of a drop volume produced by the ejection nozzle so as to move cells a predefined length in the sensing region.

Example AE: The device of any of Examples AA to AD, wherein cells moving through the microfluidic channel are, prior to ejection from the ejection nozzle, driven to a nozzle orifice by evaporation at the ejection nozzle.

Example AF: The device of any of Examples AA to AE, wherein the microfluidic device is part of a system comprising a controller to detect a cell in the microfluidic channel based on a signal waveform from the set of electrodes.

Example AG: The device of Example AF, wherein the controller fires an ejector resistor until the cell is detected.

Example AH: The device of any of Examples AA to AG, the sensing region structured to detect an electrical signal at the set of electrodes as fluid travels through the microfluidic channel.

Example AI: The device of any of Examples AA to AH, the sensing region structured to detect a current between two electrodes upon application of a potential to the set of electrodes.

Example BA: A method comprising detecting a cell traveling through a microfluidic channel of a microfluidic device, the microfluidic device comprising a sensing region, the sensing region comprising a set of electrodes flanking the microfluidic channel on two opposing sides, the electrodes having an electrode axis parallel to a channel axis of the microfluidic channel such that the cell encounters at least two electrodes simultaneously, wherein detecting the cell comprises: detecting an electrical signal at the set of electrodes; and determining that the cell is present at the sensing region based on the electrical signal.

Example BB: The method of Example BA, further comprising applying a voltage to the set of electrodes, wherein the electrical signal results from application of the voltage.

Example BC: The method of Example BB, wherein the electrical signal is a current generated at the set of electrodes due to the voltage applied to the set of electrodes.

Example BD: The method of any of Examples BA to BC, wherein the cell is determined to be present at the sensing region based on a signal waveform of the electrical signal.

Example BE: The method of Example BD, wherein the cell is determined to be present at the sensing region based on a peak-to-peak signal waveform of a current detected at the set of electrodes.

Example BF: The method of any of Examples BA to BE, further comprising driving the cell through the microfluidic channel via evaporation driven flow resulting from evaporation at a nozzle positioned downstream of the sensing region.

Example BG: The method of Example BF, further comprising firing an ejection resistor until determining that the cell is present at the sensing region based on the electrical signal.

Example CA: A microfluidic system, the system comprising a microfluidic device comprising: a microfluidic channel fed by a reservoir, the microfluidic channel comprising a sensing region with a set of electrodes, the set of electrodes comprising a positive electrode, a negative electrode, and a ground electrode, the positive electrode, the negative electrode, and the ground electrode having an electrode axis parallel to a channel axis of the microfluidic channel, the positive electrode and the negative electrode positioned on a first side of the microfluidic channel, and the ground electrode positioned on a second side of the microfluidic channel opposing the first side of the microfluidic channel; wherein the microfluidic channel and the set of electrodes are arranged such that a cell traveling through the microfluidic channel encounters at least two electrodes simultaneously.

Example CB: The microfluidic system of Example CA, further comprising a controller determine a cell is present at the sensing region based on an electrical signal at the set of electrodes.

Example CC: The microfluidic system of Example CB, the controller determining that the cell is present at the sensing region based on a peak-to-peak signal waveform of the electrical signal.

Example CD: The microfluidic system of any of Examples CA to CC, further comprising a voltage source to apply a voltage to the set of electrodes, and a differential amplifier to detect a current resulting from the voltage.

1. A microfluidic device comprising:
a microfluidic channel connected to a reservoir;
an ejection nozzle; and
a sensing region comprising a set of electrodes flanking the microfluidic channel on two sides,
the set of electrodes comprising a positive electrode, a negative electrode, and a ground electrode, the positive electrode and the negative electrode positioned on a first side of the microfluidic channel, and the ground electrode positioned on a second side of the microfluidic channel opposing the first side of the microfluidic channel,
the positive electrode, the negative electrode, and the ground electrode having an electrode axis parallel to a channel axis of the microfluidic channel.

2. The microfluidic device of claim 1, wherein the microfluidic channel and the set of electrodes are arranged such that a cell traveling through the microfluidic channel encounters at least two electrodes simultaneously.

3. The microfluidic device of claim 1, wherein a volume of the sensing region is at least as large as a drop volume produced by the ejection nozzle.

4. The microfluidic device of claim 3, wherein a volume of the sensing region is an integer multiple of a drop volume produced by the ejection nozzle so as to move cells a predefined length in the sensing region.

5. The microfluidic device of claim 1, wherein cells moving through the microfluidic channel are, prior to ejection from the ejection nozzle, driven to a nozzle orifice by evaporation at the ejection nozzle.

6. The microfluidic device of claim 1, wherein the microfluidic device is part of a system comprising a controller to detect a cell in the microfluidic channel based on a signal waveform from the set of electrodes.

7. The microfluidic device of claim 6, wherein the controller fires an ejector resistor until the cell is detected.

8. The microfluidic device of claim 1, the sensing region structured to detect an electrical signal at the set of electrodes as fluid travels through the microfluidic channel.

9. The microfluidic device of claim 1, the sensing region structured to detect a current between two electrodes upon application of a potential to the set of electrodes.

10. A method comprising detecting a cell traveling through a microfluidic channel of a microfluidic device, the microfluidic device comprising a sensing region, the sensing region comprising a set of electrodes flanking the microfluidic channel on two opposing sides, the electrodes having an electrode axis parallel to a channel axis of the microfluidic channel such that the cell encounters at least two electrodes simultaneously, wherein detecting the cell comprises:
detecting an electrical signal at the set of electrodes; and
determining that the cell is present at the sensing region based on the electrical signal.

11. The method of claim 10, further comprising applying a voltage to the set of electrodes, wherein the electrical signal results from application of the voltage.

12. The method of claim 11, wherein the electrical signal is a current generated at the set of electrodes due to the voltage applied to the set of electrodes.

13. The method of claim 10, wherein the cell is determined to be present at the sensing region based on a signal waveform of the electrical signal.

14. The method of claim 13, wherein the cell is determined to be present at the sensing region based on a peak-to-peak signal waveform of a current detected at the set of electrodes.

15. The method of claim 10, further comprising driving the cell through the microfluidic channel via evaporation driven flow resulting from evaporation at a nozzle positioned downstream of the sensing region.

16. The method of claim 15, further comprising firing an ejection resistor until determining that the cell is present at the sensing region based on the electrical signal.

17. A microfluidic system, the system comprising a microfluidic device comprising:
a microfluidic channel fed by a reservoir, the microfluidic channel comprising a sensing region with a set of electrodes, the set of electrodes comprising a positive electrode, a negative electrode, and a ground electrode,
the positive electrode, the negative electrode, and the ground electrode having an electrode axis parallel to a channel axis of the microfluidic channel,
the positive electrode and the negative electrode positioned on a first side of the microfluidic channel, and the ground electrode positioned on a second side of the microfluidic channel opposing the first side of the microfluidic channel;
wherein the microfluidic channel and the set of electrodes are arranged such that a cell traveling through the microfluidic channel encounters at least two electrodes simultaneously.

18. The microfluidic system of claim 17, further comprising a controller determine a cell is present at the sensing region based on an electrical signal at the set of electrodes.

19. The microfluidic system of claim 18, the controller determining that the cell is present at the sensing region based on a peak-to-peak signal waveform of the electrical signal.

20. The microfluidic system of claim 17, further comprising a voltage source to apply a voltage to the set of electrodes, and a differential amplifier to detect a current resulting from the voltage.
